(19) United States
(12) Patent Application Publication
(10) Pub. No.: US 2010/0289703 A1
(43) Pub. Date: Nov. 18, 2010

(54) ANTENNAS FOR SHIELDED DEVICES

(75) Inventor: Tao Huang, Eindhoven (NL)

Correspondence Address: Philips Intellectual Property and Standards, P.O. Box 3001, Briarcliff Manor, NY, 10510-8001, US

(73) Assignee: KONINKLIJKE PHILIPS ELECTRONICS N V, Eindhoven (NL)

(21) Appl. No.: 12/377,511

(22) PCT Filed: Aug. 28, 2007
(86) PCT No.: PCT/IB07/53445

§ 371 Date: Aug. 2, 2010

(30) Foreign Application Priority Data
Sep. 6, 2006 (EP) 06120238.8

(51) Int. Cl. H01Q 1/24

(52) U.S. Cl. 343/702

(57) ABSTRACT

A device comprises a conductive casing and a radio device located inside the casing. A pair of wires run from the radio device to an opening in the casing, wherein at least one of the wires carries a signal from or to the radio device. The pair of wires pass through the opening and are configured such that inside the casing they function as a transmission line and outside the casing, they are formed into an antenna. In one embodiment, one of the wires is a ground wire and the other is a live wire and, outside the casing the ground wire terminates and the live wire extends to form a monopole antenna. In another embodiment, both wires carry the signal and function as a balanced transmission line, and outside the casing the wires are separated and form a dipole antenna.

The present invention relates to providing antennas for shielded devices i.e. radio devices which are located inside a conductive casing. The conductive casing shields the inside of the casing from electromagnetic radiation and therefore providing an antenna for efficient transmission or reception by the radio device inside of the casing is a problem.

There are a number of examples of devices wherein radio transmitting and/or receiving devices may be provided inside a metal casing, such as digital set top boxes for television reception or transmitters located inside cars, where the metal car body itself serves as a shielding casing. However, one particular example is in light fittings, particularly luminaires. Luminaires such as those used in office environments generally comprise a metal casing for holding fluorescent lighting tubes and additionally include a number of other metal elements arranged as reflector elements to reflect light from behind or in front of the fluorescent tubes in a manner designed to provide comfortable lighting for the work environment.

Wireless lighting control systems for such luminaries are now being developed. Such systems allow for computer control of lighting in a building by a wireless personal area network (WPAN). One suitable such network is a ZigBee network. This network uses small, low powered digital radios based on the IEEE802.15.4 standard, and operates in the ISM radio bands, being 868 MHz in Europe, 915 MHz in the US and 2.4 GHz in most jurisdictions worldwide. The ZigBee technology is simpler and cheaper than other WPANs such as Bluetooth.

Constrained by safety regulations and commercial implications, the radio module has to be fitted inside the luminaire, typically inside the metal casing behind the lamp, the circuit ballast and perhaps also behind a reflector. Typically, the radio devices include simple monopole wire antennas, but when sealed inside a metal cage, these antennas do not function properly. One possible solution is to use a coaxial cable to bring the radio signal from the device to an antenna outside the cage. However, this approach can be costly due to the cost of the coaxial cable and associated RF connectors and a separate external antenna. Another approach is to purposely open slots or apertures in the metal cage in order to allow the wire antenna to communicate via the apertures. However, this involves a change in the manufacturing of the luminaires themselves, which is not always commercially viable and there may also be safety regulations preventing this option.

A simple solution would be to extend the length of the wire until it protrudes through the casing via a small hole, preferably a pre-existing hole. This may be commercially acceptable, but the wire antenna may still not function efficiently. Antennas are resonant devices and work selectively to their resonant frequency, which is dependent on certain physical dimensions of the antenna. For wire antennas, this means mainly the wire length. Different lengths have different input impedances. When the impedance is matched (to a given length) the antenna receives the radio signal. Otherwise for other lengths, the antenna is mismatched and the radio signal is rejected. Even if the extended wire length happens to be the antenna resonant length, radiation and reception will still occur inside the shielded device and could also produce strong cavity modes which may effect the antenna matching and cause interference with other components. The single antenna wire is also very sensitive to the aperture it protrudes through, causing strong potential fields between the wire (electrically live) and the edge (ground) of the aperture.

According to the present invention, a device comprises:
a conductive casing;
a radio device located inside the casing; and
a pair of wires running from the radio device to an opening in the casing, wherein at least one of the wires carries a signal from or to the radio device, wherein the pair of wires pass through the opening and are configured such that inside the case they function as an RF transmission line and outside the casing, they are formed into an antenna.

Therefore, the present invention uses a simple pair of wires functioning as an RF transmission line to take the radio signal from the radio device to the casing. Thus, there is no radiation or reception occurring inside the casing. Once outside the casing, the wires are formed into an antenna so that transmission and/or reception occurs outside the casing where it is not shielded by the casing. A simple pair of wires is cheaper than a coaxial cable and, as the wires are formed into the antenna outside the casing, no special connectors are required between the wires and the antenna and the wires can easily pass through a pre-existing hole in the casing.

Preferably, the pair of wires comprise insulated wires, each having a conductive wire core and surrounding insulation, wherein the insulation of the two wires is joined to maintain the wires at a substantially constant separation. Such twin wires or ribbon cables are commonly used in lighting circuits and thus are cheap and readily available.

In one embodiment, one of the wires is a live wire which carries the radio signal, and the other is connected to ground of the radio circuit. Preferably, the ground wire terminates outside the casing, and the live wire forms a monopole antenna. Preferably, the live wire extends for a quarter-wavelength beyond the end of the ground wire.

In this embodiment, the twin wire inside the casing functions as a non-balanced transmission line. The radio device may be formed on a printed circuit board, and the ground wire can simply be connected to the ground of the printed circuit board.

This embodiment is particularly applicable to devices where the shielding casing is small and hence the transmission line section is short. For devices having large casings, an alternative embodiment is preferred.

In this alternative embodiment, both of the wires carry the radio signal and function as a balanced transmission line inside the casing, and outside the casing, the wires are separated to form a dipole antenna. In order to function as a balanced transmission line, a balun is provided on the radio device and connected between the radio device and the wires. Preferably, the wires are separated to form a V-shaped half wavelength dipole antenna, or a folded V-shape dipole antenna.

The parameters of the antenna, such as the V-shape angle, dipole length, folding space and position relative to metallic surroundings outside the conductive casing can be adjusted to adjust the antenna input impedance so as to match that of the transmission line directly.

Preferably, the conductive casing comprises part of a light fitting. Preferably, the casing is metal.

Preferably, the radio device is a radio device configured for use in a wireless personal area network (WPAN). Preferably, the radio device is a ZigBee device.

Preferred embodiments of the present invention will now be described with reference to the accompanying drawings, in which:

FIG. 1 illustrates the structure of a typical luminaire;

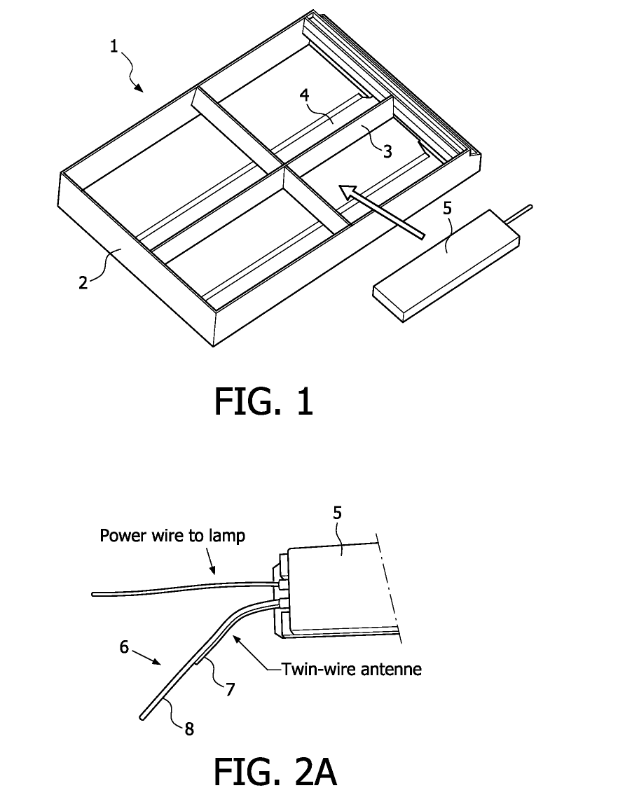

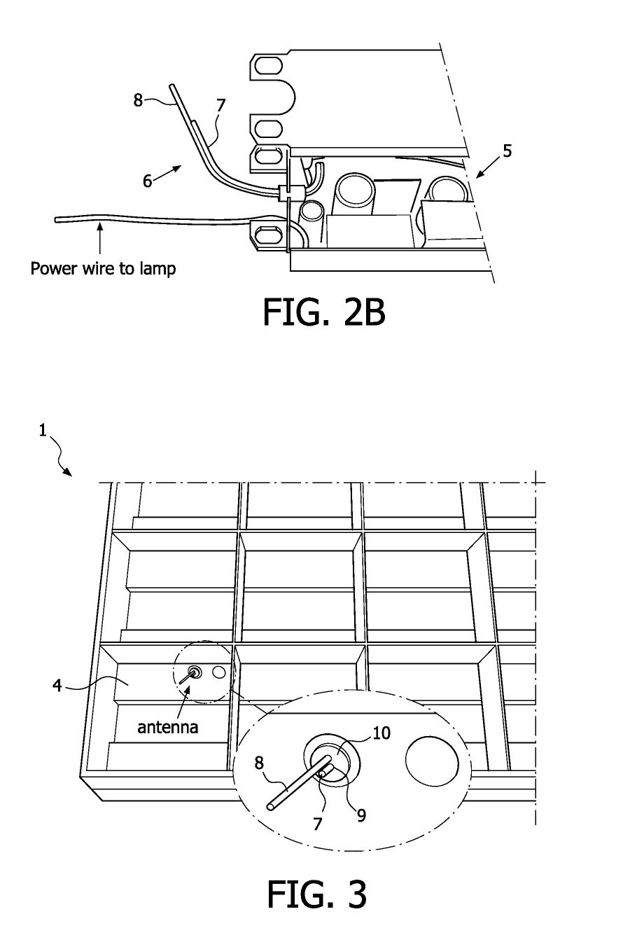

FIGS. 2A and 2B illustrate a radio controlled ballast having a monopole antenna;

FIG. 3 illustrates the ballast of FIGS. 2A and 2B installed in a luminaire;

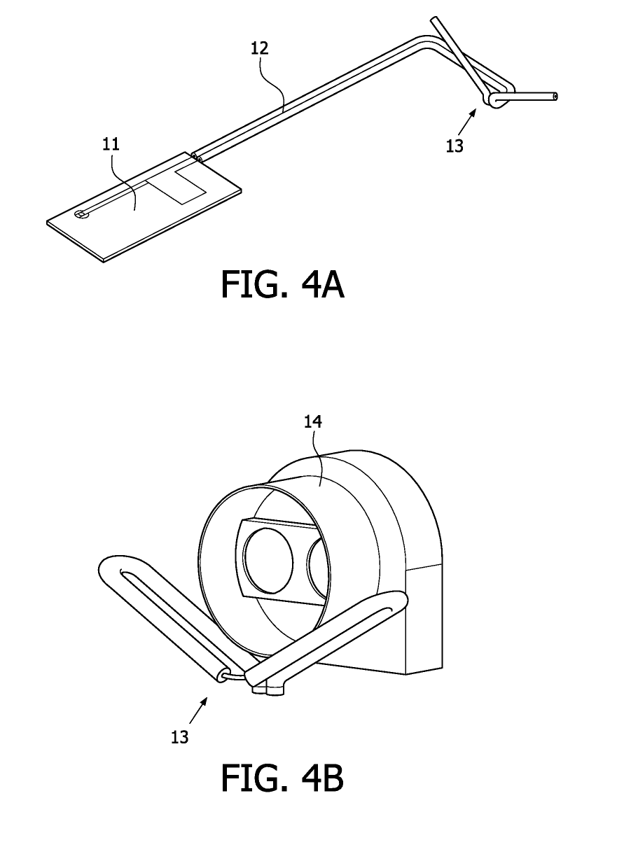

FIG. 4A illustrates a radio device having a dipole antenna;

FIG. 4B illustrates a folded dipole antenna; and

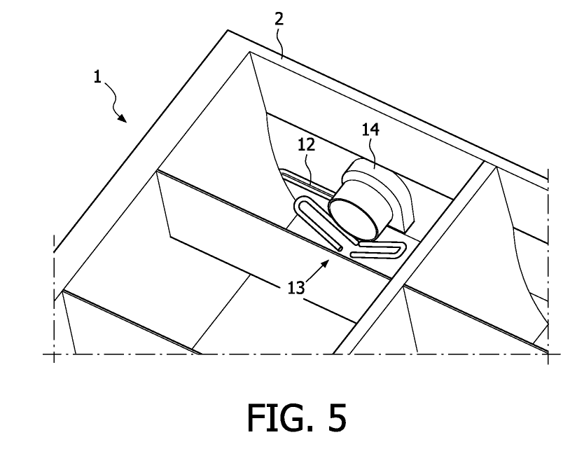

FIG. 5 illustrates the device of FIG. 4B installed in a luminaire.

The present invention relates to the provision of antennas for radio devices located inside a conductive casing, and two embodiments of the invention will now be described in which the conductive casing is a luminaire 1. FIG. 1 illustrates the structure of a typical luminaire. The luminaire 1 comprises a metal outer casing 2 and front light reflectors 3 which sub-divide the outer casing 2 into a plurality of cells. The front light reflectors 3 are typically also made of metal. At the back of the outer casing 2, ballast covers 4 are provided. The radio controlled ballast 5 is located behind the ballast cover 4. The ballast 5 is the circuitry required to control the current to the fluorescent lamp (not shown in FIG. 1).

FIGS. 2A and 2B show a radio controlled ballast having an antenna formed from a twin wire in accordance with a first embodiment of the present invention. As shown in FIG. 2A, the radio controlled ballast comprises a casing, having circuitry therein as shown in FIG. 2B. The antenna 6 comprises a twin wire which protrudes from the casing. The twin wire comprises a ground wire 7 and a live wire 8. The ground wire 7 is connected to a ground terminal of the circuitry inside the radio controlled ballast 5, and the live wire 8 is connected to a radio transmitting/receiving device which forms part of the circuitry. The ground wire 7 and the live wire 8 are maintained parallel to each other, and are formed from the type of twin wire commonly used in lighting devices, in which the two wires are joined by a portion of the insulation. The wires could also be a twisted pair. The ground wire 7 is shorter than the live wire 8, which extends beyond the end of the ground wire 7 by a quarter of a wavelength.

In use, the portion of the twin wire whereby the ground wire 7 and live wire 8 are parallel acts as an unbalanced transmission line and does not radiate. However, the section of the live wire 8 which extends beyond the end of the ground wire 7 functions as a monopole antenna.

FIG. 3 illustrates the radio controlled ballast 5 of FIGS. 2A and 2B installed in a luminaire 1. The ballast 5 is fixed behind the ballast cover 4 and the twin wire is bent such that it protrudes through a hole 9 in the ballast cover 4. Typically, these holes are pre-existing “emergency holes” (such as those for emergency lighting bulbs) and a simple fixing device or plug 10 having holes shaped to fit the wires is provided in the hole 9 to hold the wires 7, 8 in position. As can be seen in FIG. 3, the ground wire 7 protrudes only a very short distance through the hole 9, preferably less than a centimetre, and then the portion of the live wire 8 which functions as a monopole antenna extends out of the ballast cover 4. Thus, the portion of the twin wire which functions as a non radiating transmission line is located inside the metal casing of the luminaire 1, but the transmitting/receiving antenna portion is located outside the metal casing. Thus, the antenna transmits or receives outside the conductive casing, free from any shielding effect of the casing.

FIGS. 4A, 4B and 5 illustrate second and third embodiments of the present invention. In these embodiments, the radio device is formed on a printed circuit board 11. The radio signal is carried to or from the printed circuit board 11 by a twin wire 12 functioning as a balanced transmission line. The wire used is of the type commonly used in light circuits, being a pair of wire conducting cause surrounded by insulation, wherein the insulation is connected so that the wires are maintained parallel, as in the first embodiment. For the twin wire 12 to function as a balanced transmission line, a balun is also formed on the printed circuit board 11 in order to match the impedance of the radio device to the impedance of the transmission line. The pair of wires 12 carry the signal from the radio device and at the end portions, the wires 12 are separated and bent in opposite directions to form a V-shape dipole antenna 13 as shown in FIG. 4A, or a V-shape folded dipole 13 as shown in FIG. 4B which is positioned behind the lamp cap 14. The dipole will typically have a length of a half wavelength.

FIG. 5 shows the device of FIG. 4B mounted in a luminaire 1. The printed circuit board 11 is usually hosted inside the radio control ballast and mounted in the luminaire 1 behind the light reflector. The wires 12 carry the signal to the casing 2 of the luminaire and pass through the gap at the end which is used for lighting wires and are then separated to form the V-shape dipole antenna 13 outside the casing 2.

With respect to the two embodiments, the choice of whether to use the first embodiment, in which the twin wire is formed into a monopole antenna or one of the second or third embodiments where the twin wire is used as a balanced transmission line and is formed into a dipole antenna will depend on the configuration of the luminaire. If the distance between the radio device and the casing is small, then the first embodiment may be more appropriate. This is because, as the distance increases, it may become necessary to connect the ground wire 7 to ground at both ends i.e. inside the radio controlled ballast 4 and where the wires project through the hole 9 in the casing. Therefore, when the distance is greater, the second or third embodiment is preferred, even though this requires the use of a balun to allow the twin wires to operate as a balanced transmission line.

1. A device comprising:
a conductive casing;
a radio device located inside the casing; and
a pair of wires running from the radio device to an opening in the casing, wherein at least one of the wires carries a radio signal from or to the radio device, wherein the pair of wires pass through the opening and are configured such that inside the casing they function as an RF transmission line for the radio signal and outside the casing, they are formed into an antenna for transmitting or receiving the radio signal.

2. A device according to claim 1, wherein the pair of wires comprise insulated wires, each having a conducting wire core and surrounding insulation, wherein the insulation of the two wires is joined to maintain the wires at a substantially constant separation.

3. A device according to claim 1, wherein one of the wires is a live wire which carries the radio signal, and the other is connected to ground.

4. A device according to claim 3, wherein the ground wire terminates outside the casing, and the live wire forms a monopole antenna.

5. A device according to claim 4, wherein the live wire extends for a quarter wavelength beyond the end of the ground wire.

6. A device according to claim 1, wherein both of the wires carry the radio signal and function as a balanced transmission line, and outside the casing, the wires are separated to form a dipole antenna.

7. A device according to claim 6, comprising a balun between the radio device and the wires.

8. A device according to claim 1, wherein the casing comprises part of a light fitting.

9. A device according to claim 1, wherein the casing is metal.

10. A device according to claim 1, wherein the radio device is a radio device configured for use in a wireless personal area network (WPAN).

11. A device according to claim 10, wherein the radio device is a ZigBee device.
